(19) United States
(12) Patent Application Publication
(10) Pub. No.: US 2016/0040473 A1
(43) Pub. Date: Feb. 11, 2016

(54) SASH WINDOW FOR ASEPTIC ENCLOSURES

(71) Applicant: KIRO ROBOTICS, S.L., ARRASATE ( GIPUZKOA ) (ES)

(72) Inventors: Jean-Philippe Aguerre, ITXASSOU (FR); Gorka Garcia Etxebarria, ELORRIO (BIZKAIA) ( BIZKAIA ) (ES); Alaitz Cristobal Izagirre, ARETXABALETA (GIPUZKOA) (GIPUZKOA) (ES); Susana Soto Iglesias, ARRASATE-MONDRAGON (GIPUZKOA) ( GIPUZKOA (ES); Naiara Telleria Garay, ARRASATE-MONDRAGON ( GIPUZKOA ) (ES)

(21) Appl. No.: 14/716,304

(22) Filed: May 19, 2015

(30) Foreign Application Priority Data
Aug. 6, 2014 (ES) 201431203

(51) Int. Cl. E06B 3/44; E06B 5/00; E06B 7/22; E06B 1/36

(52) U.S. Cl. CPC E06B 3/4407; E06B 1/36; E06B 5/00; E06B 7/22

(57) ABSTRACT

The window has a fixed frame and a panel that can move vertically along said fixed frame, said moveable panel having a high open position, which may be partial or total, and a low closed position of the window, in which the vertical sides of the fixed frame of the window comprise straight grooves parallel to said sides, which have elbows at their lower ends directed towards the interior, that is, towards the aseptic enclosure, defining a position of the window in which the moveable panel is separate from the internal portion corresponding to the aseptic enclosure and a low position in which pressure is applied by the moveable panel to the compressible resilient joints associated with the inner edges of the fixed frame.

### CROSS-REFERENCE TO RELATED APPLICATION

This application claims priority to Spanish Patent Application No. 201431203 filed on Aug. 6, 2014, the disclosure of which including the specification, the drawings, and the claims is hereby incorporated by reference in its entirety.

The present invention relates to a sash window intended for use in enclosures of the type known as aseptic enclosures, that is, enclosures that are kept under highly aseptic conditions to allow pharmaceutical, biological or similar processes to be performed in the interior thereof.

Various types of windows are provided in aseptic enclosures at present, often including those that have windows known as sash windows, which have a closing panel provided, for example, with transparent glass, which is capable of moving vertically from a high open position to a low closed position. These windows are easy to use and generally do not have the complications and cost associated with windows that have hinges or hinge-type fittings, etc. In order to achieve the exceptional seal necessary for aseptic enclosures, the windows used at present comprise systems with resilient joints which are compressed by pressure systems which may be complex or which are subject to the pressure of a fluid contained inside said joints once the window has adopted the closed position.

The known systems, which have been described in outline, are very complicated and therefore very costly. For this reason, an object of the present invention is to disclose a sash window for aseptic enclosures that has simple characteristics and that is highly effective in operation.

The sash window of the present invention is based fundamentally on a vertically sliding panel assembly, that is, which can have a high open position and a low closed position, with a frame in which said panel is encased and slides. The frame has on the edges of the opening thereof and in the position that corresponds to the aseptic enclosure, resilient compressible sealing joints, these being combined with the guiding of the sliding panel in the fixed frame which is determined by guides formed by longitudinal grooves parallel to the sides of the fixed frame of the window, along which the moveable panel slides by means of rollers introduced in said guides, the grooves having elbows in the lower portion thereof directed towards the inner portion of the window, that is, towards the aseptic enclosure and therefore also towards the compressible joints provided on the inner edges of the fixed frame of the window. In this way, two very differentiated zones are defined for sliding the vertical panel of the window, a zone where the panel is moveable along the straight guides parallel to the edges of the fixed frame, which correspond to the raising and lowering movements of the window and shorter zones in which the panel is guided by the aforementioned elbows, so that when the panel descends vertically it comes progressively closer to the compressible joints, pressing said joints and thus increasing the sealed closure characteristics of the window. When the sliding panel of the window has reached the low position, that is, the closed position, said panel is in a position where the joints of the window are compressed, the compression being produced by the automatic approach of the moveable panel to the interior of the sealed enclosure, that is, against the compressible joints, at the end of the descent of the moveable panel.

The structure of the grooves on the vertical sides of the fixed frame of the window will vary, but must in all cases meet the condition that the greatest portion of their travel is straight and parallel to the sides of the frame and to the lower allowed portion, which may be much shorter, inclined at an angle, by curvature or other means towards the interior the aseptic enclosure, which represents the above-mentioned operation in which the vertically moveable panel automatically moves closer to the compressible joints at the end of its descending travel when closing, pressing on said joints and increasing the seal.

The number of grooves on the sides of the frame will vary, and it may be two or more with the same structural characteristics as those mentioned, allowing correct vertical guiding of the panel of the sash window and an automatic closure effect as it reaches the lower closure position by the action of automatically applying the slideable panel against the compressible joints associated with the fixed frame of the window.

To make it easier to move the panel of the window relative to the fixed frame, small fixed rollers will preferably be provided fixed to the moveable panel and inserted in the grooves of the fixed frame, which will reduce friction and allow smooth operation of the window.

Although the actual weight of the sliding panel of the sash window may be sufficient to achieve the stability thereof in the closed position, auxiliary elements for holding the moveable panel in the closed position may be provided, to improve the stability of the window in the closed position.

For a better understanding, the accompanying drawings of a preferred embodiment of a sash window according to the present invention are provided as an explanatory but not limiting example.

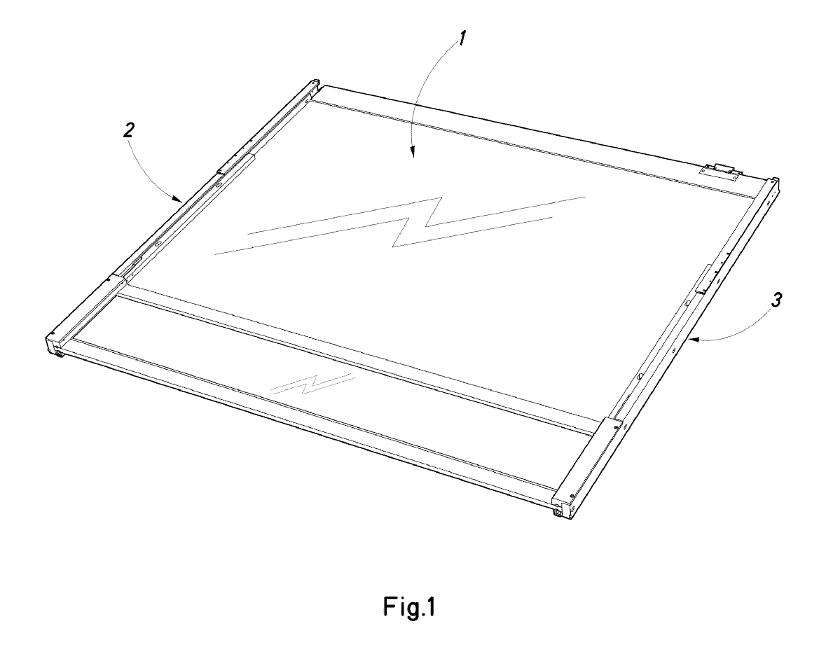

FIG. 1 is a perspective view of a sash window according to the present invention, in the closed position.

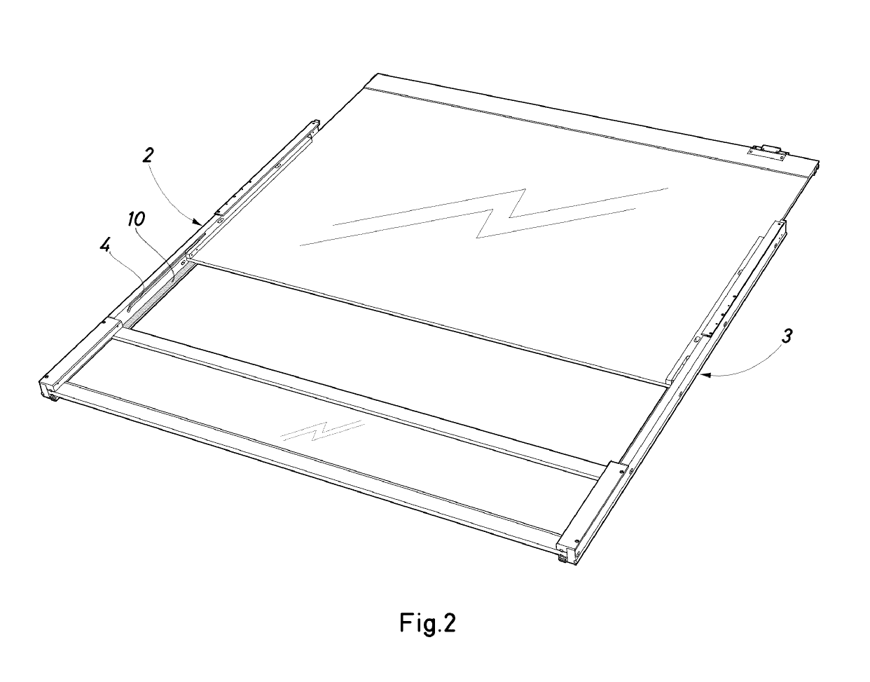

FIG. 2 is a perspective view of a sash window according to the present invention, in the half-open position.

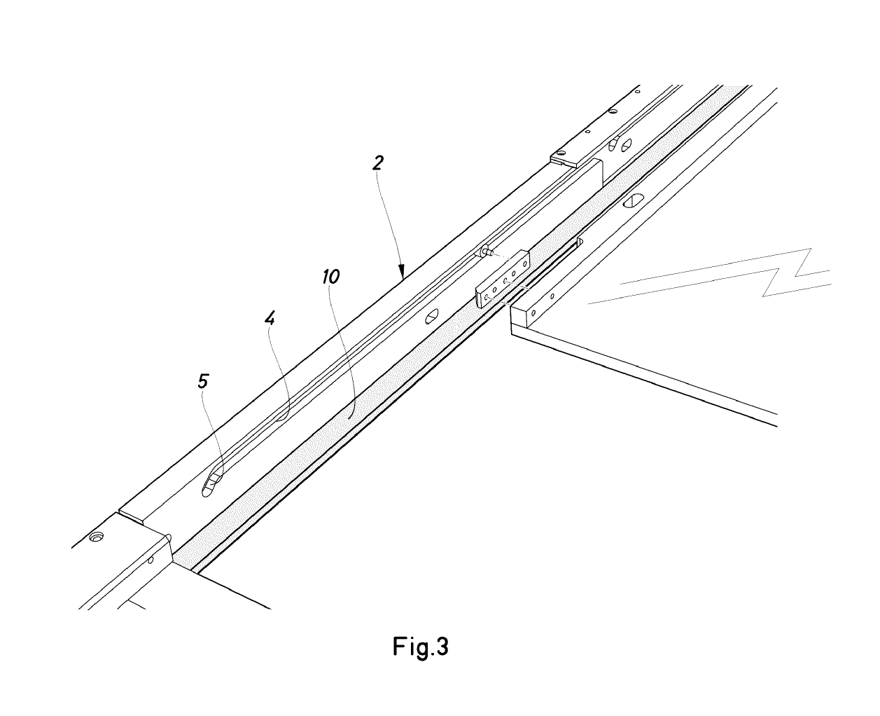

FIG. 3 is a perspective view of a portion of a fixed frame of the window according to the present invention and a portion of the moveable panel along the length thereof.

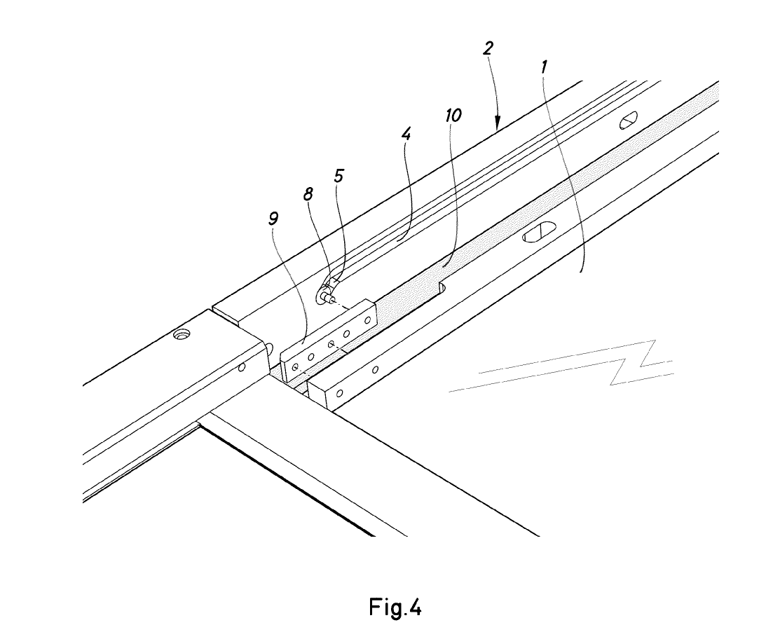

FIG. 4 is a perspective view similar to that of FIG. 3 on a larger scale, showing the position of a guide roller in the bottom of an elbow of a groove of the fixed frame.

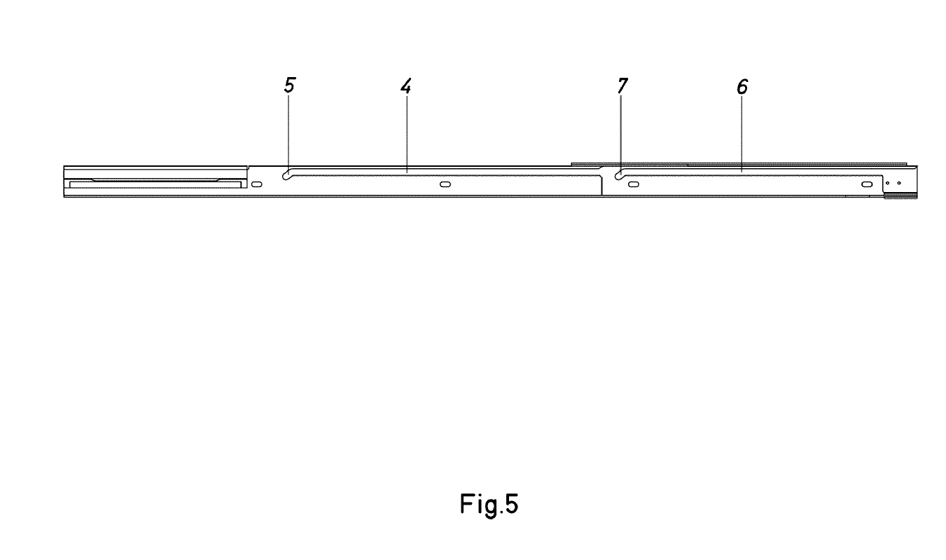

FIG. 5 is a view in side elevation of one of the sides of the fixed frame of the window.

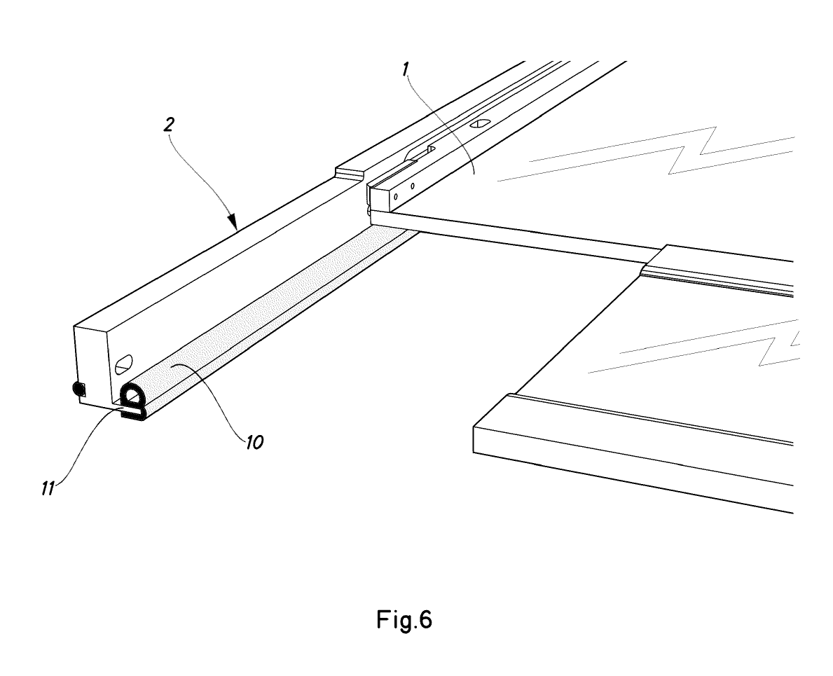

FIG. 6 is a perspective view in which the relative arrangement of the fixed frame of the window and the moveable panel thereof can be seen, as can the compressible sealing joints.

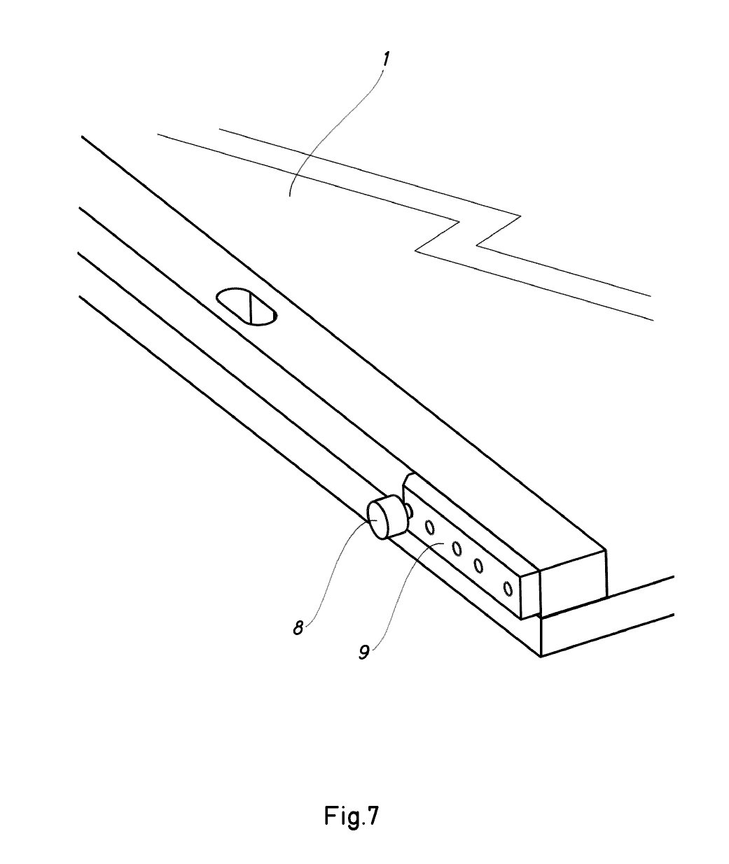

FIG. 7 is a detail of the moveable panel with a guide roller and a plate for adjusting the position of the roller.

As shown in the drawings, the sash window according to the present invention comprises a moveable panel 1 which can be moved vertically along the vertical sides 2 and 3 of the fixed frame of the window, said sides having longitudinal grooves 4 on their inner face, FIG. 2 and seq., which have straight zones parallel to the sides of the fixed frame and which have straight, curved or other elbows 5 at the lower end, directed towards the interior of the aseptic enclosure. The number of grooves 4 may vary, two being shown in FIG. 5 designated by the numerals 4 and 6, and having respective elbowed ends 5 and 7. The number of said longitudinal guides may vary depending on the characteristics of the sash window, in order to achieve correct vertical guiding thereof and an effective seal in the closed position.

FIG. 4 shows a schematic detail on a large scale in which the guide 4 of the side 2 with its elbowed end 5 can be seen, a roller 8 being shown that can move inside said grooves 4, 5 or 6, 7 (FIG. 5).

Although the drawings show the elements of the window in the inclined position, for reasons of improved clarity, it should be understood that the position of the window will normally be vertical, that is, the sides 2 and 3 will be in a vertical position.

FIG. 4 shows diagrammatically the moveable panel 1, in which the rollers 8 that slide inside the grooves of the fixed sides of the frame are fitted, intermediate blocks 9 being eventually provided to make it easier to replace said rollers should they break. The multiple orifices are intended for precise positioning (two for fixing with screws and two for positioning pins).

The closure is sealed by means of resilient compressible joints 10, as shown in FIG. 6, arranged on the sides of the fixed frame of the window, the arrangement for one of the vertical sides 2 being shown in FIG. 6. The construction of the window, which has a set of grooves and guide rollers as has been explained, ensures that at the end of its vertical movement along said guides 4, 6, the existence of the elbows 5, 7 guides the closure panels 1 so that they come closer to the edges 11 of the fixed sides of the frame, as can be seen in FIG. 6, thus pressing the joints 10 and ensuring a good seal. Thus, handled normally, the sash window will therefore be raised manually for opening in the conventional way, being moved away initially from the bottom of the window, that is, from the side that corresponds to the aseptic enclosure, by the existence of the elbows 5 and 7, the raising movement of the window continuing along the straight portions of the grooves, and in the closing manoeuvre, the moveable panel will be moved vertically over the straight portions of the guides and on reaching the elbows 5, 7 by the action of the force of gravity it will be applied against the compressible joints, producing a sealed closure of the window.

As will be understood, the description of a preferred embodiment of the present invention does not constitute a limitation on the production of the details constituting said invention, and it should be understood that persons skilled in the art, after interpreting the description, claims and accompanying drawings, may introduce multiple variants to the sash window of the invention, which will fall within the scope of the invention if they are included within the scope of the accompanying claims. In particular, it should be noted that although an embodiment has been shown in which the rollers are in the glass and the guides are in the frame, provision can also be made for the reverse arrangement with the same result, that is, the guides in the glass and the rollers in the frame.

What is claimed is:

1. Sash windows for aseptic enclosures, of the type that comprises a fixed frame associated with the opening of the window and a panel that can slide vertically along said fixed frame, said slideable panel having a high open position, which may be partial or total, and a low closed position of the window, characterised in that the vertical sides of the fixed frame of the window comprise straight grooves parallel to said sides, which have elbows at their lower ends directed towards the interior, that is, towards the aseptic enclosure, defining a position of the window in which the moveable panel is separate from the internal portion corresponding to the aseptic enclosure and a low position in which the moveable panel is applied under pressure against the compressible resilient joints associated with the inner edges of the fixed frame, producing a seal for the window due to the pressure exerted on said compressible joints.

2. Window according to claim 1, characterised in that the vertical sides of the fixed frame of the window have one or more successive grooves with the same characteristics, with a straight portion parallel to the sides and lower ends inclined inwards at the ends, for guiding the moveable panel of the window over its entire travel and to ensure a correct position for applying pressure to the compressible joints of the fixed frame, in the closed position.

3. Window according to claim 1, characterised in that the sides of the moveable frame of the window have intermediate blocks with multiple orifices to hold the guide rollers, so that said guide rollers can be replaced should they break.

4. Window according to claim 1, characterised in that the moveable panel of the window has rollers which run along the grooves of the vertical sides of the fixed frame.
